(19) United States
(12) Patent Application Publication
(10) Pub. No.: US 2024/0309215 A1
(43) Pub. Date: Sep. 19, 2024

(54) TREATED TITANIUM DIOXIDE PIGMENT

(71) Applicant: Tronox LLC, Oklahoma City, OK (US)

(72) Inventors: Venkata Rama Rao Goparaju, Edmond, OK (US); Quan Su, Edmond, OK (US); Charles Stewart Christ, JR., Edmond, OK (US)

(21) Appl. No.: 18/123,144

(22) Filed: Mar. 17, 2023

(51) Int. Cl. C09C 1/36

(52) U.S. Cl. CPC C09C 1/3669; C09C 1/3661; C01P 2004/62

(57) ABSTRACT

A process for producing a treated, titanium dioxide pigment is provided. The process comprises providing a plurality of inorganic pigment particles, and depositing an organic treating agent on the surfaces of the pigment particles to form at least one coating of the organic treating agent thereon. The organic treating agent includes a first component consisting of at least one polyhydric alcohol, and a second component selected from the group consisting of carboxylic acids and salts thereof, alkanolamines, and combinations thereof. A treated, titanium dioxide pigment is also provided.

### BACKGROUND

Titanium dioxide is an effective pigment and white opacifying agent that is used in a variety of applications. For example, titanium dioxide pigment is commonly added to polymers, coatings (e.g., aqueous paint and ink formulations), paper and other types of products. Due to its high refractive index, strong opacifying ability and other factors, titanium dioxide (TiO₂) has become one of the most commonly used white pigments throughout the world.

Purified titanium dioxide (TiO₂) is produced from raw ore (for example, ilmenite and rutile) by either the sulfate process or the chloride process. Each process can produce the pigment in its rutile crystalline form. The sulfate process can also produce the pigment in its anatase crystalline form, which can be softer and particularly useful in certain applications. The produced titanium dioxide pigment is generally in powder form.

Whether produced by the sulfate process or the chloride process, the produced titanium dioxide particles are generally further processed to form a finished pigment. The steps utilized in the finishing process depend on the specific pigment properties and characteristics desired for the intended application.

For example, the produced titanium dioxide is typically coated with one or more inorganic materials to modify or enhance the properties and characteristics of the pigment for particular applications. Examples of inorganic materials utilized include silica, zirconia and alumina. For example, such materials can function to improve the opacity, light stability and/or durability of the pigment. The inorganic materials are normally coated on to the titanium dioxide particles by forming an aqueous slurry of the particles and depositing the inorganic materials on the surfaces of the particles in the slurry.

A primary property that a titanium dioxide pigment contributes to paint, paper, plastic and other products is hiding power. The hiding power of a titanium dioxide pigment is based on the ability of the pigment to scatter light in the base product (for example, a paint formulation) to which it is added. The ability of the pigment to scatter light in the base product to which it is added (the light scattering efficiency of the pigment) depends on various factors, including the particle size distribution of the pigment, the difference in refractive index of the pigment particles and their surroundings. The titanium dioxide pigment surface treatments, particle size and particle size distribution also affect the surface gloss and grits of the dry coating films.

Following treatment of the titanium dioxide pigment with one or more inorganic materials in the slurry stage, the treated titanium dioxide pigment is typically then filtered, washed and dried. The dry treated pigment is then milled in a fluidized energy mill such as a steam micronizer to break down agglomerates of the pigment. At least one organic chemical is normally added to the dry agglomerated titanium dioxide pigment in the fluid energy mill to serve as a grinding aid and facilitate the milling process. The organic chemical, which is generally coated onto the surface of the titanium dioxide particles, can also improve the performance of the pigment in its end-use application(s).

Trimethylolpropane (TMP) is an organic compound that has been widely used to surface treat titanium dioxide pigment particles for various purposes. For example, TMP has commonly been used as a grinding aid in the milling process and generally used to improve the flow and dispersion properties of the pigment. Unfortunately, a TMP consortium associated with the Registration, Evaluation, Authorization and Restriction of Chemicals (REACH) regulation of the European Union has self-classified TMP as a suspected reproductive toxicant. As a result, there is a need for other organic treating agents that can be substituted for TMP.

### SUMMARY

A process for producing a treated, titanium dioxide pigment, comprising: providing a plurality of titanium dioxide pigment particles; and depositing an organic treating agent on the surfaces of the pigment particles to form a coating of the organic treating agent thereon. The organic treating agent includes: a first component consisting of at least one polyhydric alcohol; and a second component selected from the group consisting of carboxylic acids and salts thereof, alkanolamines, and combinations thereof.

A treated, titanium dioxide pigment, comprising: a plurality of titanium dioxide pigment particles; and an organic treating agent deposited on the surfaces of the titanium dioxide pigment particles and forming a coating of the organic treating agent thereon. The organic treating agent includes: a first component consisting of at least one polyhydric alcohol; and a second component selected from the group consisting of carboxylic acids and salts thereof, alkanolamines, and combinations thereof.

### DETAILED DESCRIPTION

The present disclosure may be understood more readily by reference to this detailed description as well as to the examples included herein. Numerous specific details are set forth in order to provide a thorough understanding of the various aspects of this disclosure. However, this detailed description is not to be considered as limiting the scope of the claims. The subject matter disclosed herein is capable of considerable modifications, alterations, combinations, and equivalents in form and function, as will be evident to those skilled in the art with the benefit of this disclosure.

Whenever a range is disclosed herein, the range includes independently and separately every member of the range extending between any two numbers enumerated within the range. Furthermore, the lowest and highest numbers of any range shall be understood to be included within the range set forth.

In one aspect, a process for producing a treated, titanium dioxide pigment is disclosed herein. In another aspect, a treated titanium dioxide pigment is disclosed herein.

The process disclosed herein comprises providing a plurality of titanium dioxide particles, and depositing an organic treating agent on the surfaces of the pigment particles to form a coating of the organic treating agent thereon. The organic treating agent includes a first component consisting of at least one polyhydric alcohol, and a second component selected from the group consisting of carboxylic acids and salts thereof, alkanolamines, and combinations thereof.

As used herein and in the appended claims, a titanium dioxide pigment means a particulate titanium dioxide, that is a titanium dioxide pigment in the form of a plurality of titanium dioxide pigment particles. For example, the titanium dioxide can be in dry powder or dry granule form. As used herein and in the appended claims, “deposited on,” formed on,” and “precipitated on” the surfaces of the titanium dioxide or pigment particles (or another component such as another coating) means deposited, formed or precipitated (as the case may be) directly or indirectly on the surfaces of the titanium dioxide or pigment particles (or other component), unless stated otherwise. For example, unless stated otherwise, a treating agent deposited on the surfaces of the titanium dioxide particles means the treating agent is formed directly on the titanium dioxide particles or on one more organic and/or inorganic coatings that are directly or indirectly formed on the titanium dioxide particles.

For example, the titanium dioxide particles can be provided by producing the titanium dioxide pigment as part of the process disclosed herein. Alternatively, the titanium dioxide particles can be provided from a source of a titanium dioxide pigment that has already been produced. For example, one or more bulk containers (e.g., bags) of a pre-existing titanium dioxide pigment can be used a source of the titanium dioxide pigment.

The manner in which the titanium dioxide particles are produced, whether as part of the process disclosed herein or otherwise, is not critical. For example, the titanium dioxide particles can be titanium dioxide particles that have been produced by the sulfate process. For example, the titanium dioxide particles can be titanium dioxide particles that have been produced by the chloride process. The particles can have a rutile crystalline structure, an anatase crystalline structure, or a combination thereof. For example, the titanium dioxide particles can have a rutile crystalline structure. For example, the titanium dioxide particles can have an anatase crystalline structure.

In the sulfate process for producing titanium dioxide, a titanium slag ore, usually an ilmenite, is dissolved in sulfuric acid to form titanyl sulfate. The titanyl sulfate is then hydrolyzed to form hydrous titanium dioxide. The hydrated titanium dioxide is heated in a calciner to grow titanium dioxide crystals to pigmentary dimensions.

In the chloride process for producing titanium dioxide, a dry titanium dioxide ore is fed into a chlorinator together with coke and chlorine to produce a gaseous titanium halide (such as titanium tetrachloride). The produced titanium halide is purified and oxidized in a specially designed reactor at a high temperature to produce purified titanium dioxide particles having a desired particle size distribution. Aluminum chloride is typically added to the titanium halide in the oxidation reactor to incorporate alumina into the crystal lattice of the titanium dioxide particles and thereby facilitating rutile formation and control particle size. The titanium dioxide and gaseous reaction products are then cooled and the titanium dioxide particles are recovered.

The titanium dioxide particles can contain alumina as part of their lattice structure. For example, aluminum chloride can be added to the reactants as a rutilization aid during the vapor phase oxidation step of the chloride process. When present during the oxidation reaction, the aluminum chloride imparts alumina into the lattice structure of the pigment.

For example, the organic treating agent can be deposited on the surfaces of the pigment particles in an amount in the range of from about 0.1% to about 1% by weight, based on the weight of the titanium dioxide particles. For example, the organic treating agent can be deposited on the surfaces of the pigment particles in an amount in the range of from about 0.2% to about 0.9% by weight, based on the weight of the titanium dioxide particles. For example, the organic treating agent can be deposited on the surfaces of the pigment particles in an amount in the range of from about 0.4% to about 0.7% by weight, based on the weight of the titanium dioxide particles. As used herein and in the appended claims, unless stated otherwise, “based on the weight of the titanium dioxide particles” means based on the weight of the raw titanium dioxide particles in dry form.

For example, the ratio of the first component to the second component in the organic treating agent can be in the range of from about 1:1 to about 20:1. For example, the ratio of the first component to the second component in the organic treating agent can be in the range of from about 2:1 to about 10:1. For example, the ratio of the first component to the second component in the organic treating agent can be in the range of from about 3:1 to about 7:1. For example, the ratio of the first component to the second component in the organic treating agent can be about 5:1.

For example, the polyhydric alcohol(s) of the first component of the organic treating agent can be selected from the group consisting of glycerol, polyglycerol, mannitol, xylitol, erythritol, and combinations thereof. For example, the polyhydric alcohol(s) of the first component of the organic treating agent can be selected from the group consisting of glycerol, mannitol, xylitol, erythritol, and combinations thereof. For example, the polyhydric alcohol(s) of the first component of the organic treating agent can be selected from the group consisting of glycerol, xylitol, erythritol, and combinations thereof. For example, the polyhydric alcohol(s) of the first component of the organic treating agent can be selected from the group consisting of glycerol, xylitol, and combinations thereof. For example, the polyhydric alcohol(s) of the first component of the organic treating agent can be glycerol.

For example, the first component of the organic treating agent can be deposited on the surfaces of the pigment particles in an amount in the range of from about 0.1% to about 0.99% by weight, based on the weight of the titanium dioxide particles. For example, the first component of the organic treating agent can be deposited on the surfaces of the pigment particles in an amount in the range of from about 0.2% to about 0.9% by weight, based on the weight of the titanium dioxide particles. For example, the first component of the organic treating agent can be deposited on the surfaces of the pigment particles in an amount in the range of from about 0.4% to about 0.7% by weight, based on the weight of the titanium dioxide particles.

For example, the second component of the organic treating agent can be at least one carboxylic acid and/or salt thereof. The carboxylic acid(s) and/or salt(s) thereof can be selected from the group consisting of monocarboxylic acids, dicarboxylic acids, hydroxyl carboxylic acids, salts of monocarboxylic acids, salts of dicarboxylic acids, salts of hydroxyl carboxylic acids, and combinations thereof. For example, the carboxylic acid(s) and/or salt(s) thereof can be selected from the group consisting of benzoic acid, adipic acid, propionic acid, citric acid, lactic acid, tartaric acid, salts of benzoic acid, salts of adipic acid, salts of propionic acid, salts of citric acid, salts of lactic acid, salts of tartaric acid, and combinations thereof. For example, the carboxylic acid(s) and/or salt(s) thereof can be selected from the group consisting of benzoic acid, citric acid, lactic acid, salts of benzoic acid, salts of citric acid, salts of lactic acid, and combinations thereof. For example, the carboxylic acid(s) and/or salt(s) thereof can be selected from the group consisting of benzoic acid, lactic acid, salts of benzoic acid, salts of lactic acid, and combinations thereof. For example, the carboxylic acid(s) and/or salt(s) thereof can be selected from the group of benzoic acid and salts thereof.

For example, the second component of the organic treating agent can be at least one alkanolamine. For example, the alkanolamine(s) can be selected can be selected from the group consisting of hydroxylamines, triisopropanolamine (TIPA), triethanolamine (TEOA), tris(hydroxymethyl)aminomethane, and combinations thereof. For example, the alkanolamine(s) can be selected can be selected from the group consisting of triisopropanolamine (TIPA), triethanolamine (TEOA), and combinations thereof. For example, the alkanolamine(s) can be a triisopropanolamine (TIPA).

For example, the second component of the organic treating agent can be at least one carboxylic acid salt and/or salt thereof together with one or more alkanolamines. For example, the carboxylic acid(s) and/or salt(s) thereof can be selected from a group as set forth above. For example, the alkanolamine(s) can be selected from a group as set forth above.

For example, the second component of the organic treating agent can be deposited on the surfaces of the pigment particles in an amount in the range of from about 0.01% to about 0.9% by weight, based on the weight of the titanium dioxide particles. For example, the second component of the organic treating agent can be deposited on the surfaces of the pigment particles in an amount in the range of from about 0.03% to about 0.5% by weight, based on the weight of the titanium dioxide particles. For example, the second component of the organic treating agent can be deposited on the surfaces of the pigment particles in an amount in the range of from about 0.05% to about 0.4% by weight, based on the weight of the titanium dioxide particles.

For example, if the second component of the organic treating agent is one or more carboxylic acids or salts thereof, it can be deposited on the surfaces of the pigment particles in an amount in the range of from about 0.1% to about 0.6% by weight, based on the weight of the titanium dioxide particles. For example, if the second component of the organic treating agent is one or more carboxylic acids or salts thereof, it can be deposited on the surfaces of the pigment particles in an amount in the range of from about 0.15% to about 0.5% by weight, based on the weight of the titanium dioxide particles. For example, if the second component of the organic treating agent is one or more carboxylic acids or salts thereof, it can be deposited on the surfaces of the pigment particles in an amount in the range of from about 0.2% to about 0.4% by weight, based on the weight of the titanium dioxide particles.

For example, if the second component of the organic treating agent is one or more alkanolamines, it can be deposited on the surfaces of the pigment particles in an amount in the range of from about 0.01% to about 0.2% by weight, based on the weight of the titanium dioxide particles. For example, if the second component of the organic treating agent is one or more alkanolamines, it can be deposited on the surfaces of the pigment particles in an amount in the range of from about 0.02% to about 0.16% by weight, based on the weight of the titanium dioxide particles. For example, if the second component of the organic treating agent is one or more alkanolamines, it can be deposited on the surfaces of the pigment particles in an amount in the range of from about 0.04% to about 0.12% by weight, based on the weight of the titanium dioxide particles.

The organic treating agent can be deposited on the surfaces of the titanium dioxide pigment particles by any technique for surface treating pigments known in the art. For example, the organic treating agent can be deposited on the surfaces of the pigment particles in a fluid energy mill. The organic treating agent can be mixed with or sprayed on the pigment particles when the titanium dioxide pigment particles are in dry form. The organic treating agent can also be added to a slurry containing the pigment particles and dried therewith.

For example, in one embodiment, the process further comprises, prior to depositing the organic treating agent on the surfaces of the titanium dioxide pigment particles, forming a slurry of the pigment particles, and filtering the pigment particles to form a filter cake that includes the pigment particles. The organic treating agent is then deposited on the surfaces of the pigment particles forming the filter cake to form a coating of the organic treating agent thereon by mixing the organic treating agent with the filter cake.

For example, by the filtration step, the pigment particles are washed and recovered. The recovered pigment particles can then be dried as part of the pigment finishing process. The organic treating agent can be mixed with the filter cake before or after the filter cake is dried.

For example, the process can further comprise: after the organic treating agent is mixed with the filter cake to deposit the organic treating agent on the surfaces of the pigment particles and after the filter cake is dried, milling the treated pigment particles. For example, the pigment particles can be milled in a fluid energy mill. For example, the pigment particles can be milled by steam micronization techniques. For example, the organic treating agent serves as a grinding aid and facilitates the milling process.

For example, in one embodiment, the process further comprises, prior to depositing the organic treating agent on the surfaces of the pigment particles, depositing an inorganic treating agent on the surfaces of the pigment particles to form a coating of the inorganic treating agent thereon. For example, the organic treating agent can be deposited on top of the coating of the inorganic treating agent to form a coating thereon.

For example, a first inorganic treating agent can be deposited on the surfaces of the pigment particles to form a coating of the first inorganic treating agent thereon, and a second inorganic treating agent can be deposited on the coating of the first inorganic treating agent to form a coating of the second organic treating agent thereon. A third inorganic treating agent can then be deposited on the coating of the second inorganic treating agent to form a coating of the third inorganic treating agent thereon, and so forth and so on.

For example, when more than one inorganic treating agent is deposited on the surfaces of the pigment particles to form more than one inorganic treating agent coating thereon, the organic treating agent is deposited on top of all of the coatings of the inorganic treating agents. For example, if first and second inorganic treating agents are deposited, directly or indirectly, on the surfaces of the pigment particles, the organic treating agent is then deposited on top of the coating of the second inorganic treating agent. For example, depositing the organic treating agent on top of the coating(s) of the inorganic treating agents (and any other organic materials deposited on the surfaces of the titanium dioxide particles) can enhance the compatibility of the pigment with a polymeric resin matrix, for example, when the treated titanium dioxide pigment is added to a polyolefin.

For example, the inorganic treating agent(s) can be deposited on the surfaces of the titanium dioxide particles by forming an aqueous slurry of the titanium dioxide particles, and precipitating the inorganic treating agent(s) onto the surfaces of the titanium dioxide particles in the slurry to form one or more coating(s) of the inorganic treating agent thereon. Techniques for precipitating one or more inorganic or organic treating agents directly or indirectly on the surfaces of titanium dioxide particles such as titanium dioxide pigment particles in a slurry containing the titanium dioxide particles by successively adding each treating agent to the slurry and adjusting the pH of the slurry as necessary to cause the treating agents to precipitate on the surfaces of the titanium dioxide particles are known in the art. The inorganic and organic treating agent(s) are precipitated onto the titanium dioxide particles in situ in the aqueous slurry.

For example, in order to deposit a metal oxide inorganic treating agent on the surfaces of a plurality of titanium dioxide particles to form a coating thereon, the metal oxide inorganic treating agent can be incrementally added to the aqueous slurry as an aqueous metal oxide salt solution. The pH and temperature of the slurry can be adjusted and maintained at levels that cause precipitation of the specific metal oxide inorganic treating agent to occur. In order to control the pH of the slurry, strong inorganic acids such as hydrochloric acid, nitric acid, sulfuric acid and salts thereof can be used. For example, each separate inorganic treating agent precipitated onto the surfaces of the titanium dioxide particles in the slurry forms a separate coating directly or indirectly on the surfaces of the titanium dioxide particles.

For example, the inorganic treating agent(s) is selected from the group consisting of metal oxide materials, metal hydroxide materials, and combinations thereof. For example, the inorganic treating agent(s) is selected from the group of silica materials, alumina materials, aluminum phosphate materials, zirconia materials, and titania materials. For example, the inorganic treating agent(s) is selected from the group of silica materials, alumina materials, and zirconia materials. If more than one inorganic treating agent is utilized, the inorganic treating agents can be the same or different.

The inorganic treating agent(s) can be used to impart one or more properties and/or characteristics to the titanium dioxide particles, or enhance the same, to make the particles more suitable for the end-use application, that is, for use in the base composition (for example, the polymer composition) to which the titanium dioxide is to be added and products produced therefrom (for example, plastic articles). For example, silica and/or alumina treating agents can be used to help improve the wetting and dispersing properties of a titanium dioxide pigment as well as the opacity, light stability and durability of the pigment.

For example, the inorganic treating agent(s) can be deposited on the surfaces of the titanium dioxide particles in an amount in the range of about 0.2% by weight to about 15% by weight, based on the total weight of the raw titanium dioxide particles and all inorganic and organic materials deposited thereon. For example, the inorganic treating agent(s) can be deposited on the surfaces of the titanium dioxide particles in an amount in the range of about 0.5% by weight to about 10% by weight, based on the weight of the raw titanium dioxide particles and all inorganic and organic materials deposited thereon.

For example, in one embodiment, the organic treating agent referenced above is a second organic treating agent, and the process further comprises: depositing a first organic treating agent on the surfaces of the pigment particles to form a coating of the first organic treating agent thereon.

For example, like the second organic treating agent, the first organic treating agent can be deposited on the surfaces of the pigment particles to form a coating of the first organic treating agent thereon by any technique for surface treating pigments known in the art. For example, the first organic treating agent can be deposited on the surfaces of the pigment particles in a fluid energy mill. The first organic treating agent can be mixed with or sprayed on the surfaces of the pigment particles when the pigment particles are in dry form. The first organic treating agent can also be added to a slurry containing the pigment particles and dried therewith.

By way of further example, like the second organic treating agent, the first organic treating agent can be mixed with a filter cake containing the pigment particles as described above (either before or after the filter cake is dried). The treated pigment particles (now containing the first organic treating agent, the second organic treating agent and, optionally, one or more inorganic treating agents) can then be milled as described above.

For example, the first organic treating agent can be deposited on the surfaces of the pigment particles prior to depositing the second organic treating agent on the surfaces of the pigment particles. For example, in one embodiment, after a filter cake that includes the pigment particles is formed as described above, the first organic treating agent is deposited on the surfaces of the pigment particles forming the filter cake to form a coating of the first organic treating agent thereon. Next, the second organic treating agent is deposited on the surfaces of the pigment particles forming the filter cake to form a coating of the second organic treating agent thereon. For example, after the first organic treating agent is deposited on the surfaces of the pigment particles forming the filter cake, and prior to depositing the second organic treating agent on the surfaces of the pigment particles forming the filter cake, the filter cake can be dried. Once both of the first and second treating agents are deposited on the pigment particles forming the filter cake, the treated pigment particles (now containing the first organic treating agent, the second organic treating agent and, optionally, one or more inorganic treating agents) can then be milled as described above.

For example, the first organic treating agent can be selected from the group consisting of alkyl phosphinic acids, derivatives of alkyl phosphinic acids, phosphonic acids, derivatives of phosphonic acids, siloxanes, and combinations thereof.

Examples of alkyl phosphinic acids and derivatives of alkyl phosphinc acids that can be used include bis(2,4,4,-trimethylpentyl) phosphinic acid, bis (2-ethylhexyl phosphinic acid), oleyl phosphinic acid, n-octadecyl phosphinic acid, esters of phosphinic acids, and combinations thereof. An example of an ester of a phosphinic acid that can be used is bis(2-ethylhexyl)phosphinic acid 2-ethylhexyl ester.

Examples of phosphonic acids and derivatives of phosphonic acids that can be used include n-octylphosphonic acid, decylphosphonic acid, dodecylphosphonic acid, octylphosphonic acid, esters of phosphonic acids, salts of phosphonic acids, and combinations thereof. Examples of esters of phosphonic acids that can be used include esters of alkylphosphonic acids. An example of a salt of a phosphonic acid that can be used is monoethyl ester potassium salt.

Examples of siloxanes that can be used include polydimethyl siloxane, copolymers of polydimethyl siloxane and polymethyl hydrogen siloxane, n-octyltriethoxy silane, silicone alkylpolyethers, silicone polyether carboxylates, and combinations thereof.

For example, the first organic treating agent can be selected from the group consisting of alkyl phosphinic acids, phosphonic acids, siloxanes, and combinations thereof. For example, the first organic treating agent can consist of one or more alkyl phosphinic acids. For example, the first organic treating agent can be bis(2,4,4,-trimethylpentyl) phosphinic acid.

For example, the first organic treating agent can be deposited on the surfaces of the pigment particles in an amount in the range of from about 0.05% to about 1.0% by weight, based on the weight of the titanium dioxide particles. For example, the organic treating agent can be deposited on the surfaces of the pigment particles in an amount in the range of from about 0.1% to about 0.8% by weight, based on the weight of the titanium dioxide particles. For example, the organic treating agent can be deposited on the surfaces of the pigment particles in an amount in the range of from about 0.2% to about 0.6% by weight, based on the weight of the titanium dioxide particles.

For example, in one embodiment, the process disclosed herein comprises the following steps:
(a) providing a plurality of titanium dioxide particles;
(b) after step (a), forming an aqueous slurry of the titanium dioxide particles;
(c) after step (b), reducing the particle size of the titanium dioxide particles in the aqueous slurry to a desired particle size distribution;
(d) after step (c), depositing an inorganic treating agent (or successively depositing more than one inorganic treating agent) onto the surfaces of the titanium dioxide particles to form a coating of the inorganic treating agent thereon (or to form a separate coating for each inorganic treating agent thereon) in the aqueous slurry;
(e) after step (d), filtering the surface treated titanium dioxide particles to form a filter cake that includes the surface treated titanium dioxide particles;
(f) after step (e), mixing the organic treating agent with the filter cake to deposit the organic treating agent on the coating(s) of the inorganic treating agent(s);
(g) after step (g), drying the filter cake;
(h) after step (g), reducing the particle size of the treated titanium dioxide particles to the desired particle size distribution; and
(i) after step (i), packaging the treated, titanium dioxide. As discussed above, the titanium dioxide particles can be provided in step (a) by producing the titanium dioxide pigment as part of the process disclosed herein. Alternatively, the titanium dioxide particles can be provided in step (a) from a source of titanium dioxide that has already been produced.

A slurry of the titanium dioxide particles can be formed in step (b) by mixing the titanium dioxide particles into an aqueous medium. If necessary or desired, a dispersing agent such as a polyphosphate can be added to the aqueous slurry to facilitate distribution of the titanium dioxide particles therein. For example, the titanium dioxide particles can be added to the aqueous slurry in an amount in the range of from about 5% by weight to about 65% by weight, based on the total weight of the slurry. By way of further example, the titanium dioxide particles are added to the slurry in an amount in the range of from about 15% by weight to about 45% by weight, based on the total weight of the slurry. For example, the titanium dioxide particles are added to the aqueous slurry in an amount in the range of from about 25% by weight to about 40% by weight, based on the total weight of the slurry.

The particle size of the titanium dioxide particles can be reduced in step (c) to a desired particle size distribution by wet milling the pigment particles in the aqueous slurry. For example, the pigment particles in the aqueous slurry can be wet milled to cause at least about 50% of the titanium dioxide particles in the slurry to have a particle size of less than 0.5 microns. Various wet milling techniques known in the art can be used to carry out the wet milling step, including cage milling, bead milling, jet milling and sand milling.

The inorganic treating agent(s) can be deposited onto the surfaces of the titanium dioxide particles to form one or more coatings of the inorganic treating agent thereon in the slurry in accordance with step (d) by precipitating the inorganic treating agent(s) onto the surfaces of the titanium dioxide particles as discussed above.

The treated titanium dioxide particles can be filtered to form the filter cake that includes the surface treated titanium dioxide particles in accordance with step (e) by methods known to those skilled in the art. For example, the treated titanium dioxide particles can be recovered by filtration to form a filter cake of the particles and washed using conventional vacuum-type and/or pressure-type filtration systems. The wet treatment deposition of the inorganic treating agent(s) onto the titanium dioxide particles (for example, onto the wet-milled titanium dioxide particles) helps enable the pigment to be recovered and washed using conventional vacuum-type and/or pressure-type filtration systems.

The organic treating agent can be mixed with the filter cake in accordance with step (f) to deposit the organic treating agent on the coating(s) of the inorganic treating agent(s) by any technique known to those skilled in the art. In one embodiment, the organic treating agent is a second organic treating agent as described above, and step (f) includes mixing both the first organic treating agent and the second organic treating agent with the filter cake to deposit the organic treating agent on the coating(s) of the inorganic treating agent(s), as described above.

The filter cake can be dried in accordance with step (g) by vacuum drying, spin-flash drying, spray drying or other techniques known to those skilled in the art to produce a dry titanium dioxide powder. In one embodiment, the filter cake is dried in accordance with step (g) by spray drying the particles.

The particle size of the treated titanium dioxide particles forming the dried filter cake can be reduced to the desired particle size distribution in step (h) by, for example, dry milling the pigment particles. For example, a fluid energy mill can be used to dry mill the pigment particles. Alternatively, the dried pigment particles can be reduced to the desired particle size distribution by steam micronization (for example, steam milling) techniques.

The treated titanium dioxide can then be packaged by any packaging technique known in the art. For example, the dried and milled treated inorganic oxide pigment can be placed in bags and shipped therein.

In one embodiment, an inorganic treating agent is not deposited on the surfaces of the titanium dioxide particles, that is, step (d) is not included. In this embodiment, the first and second organic treating agents are deposited, directly or indirectly, on the surfaces of the pigment particles.

The treated titanium dioxide pigment provided herein comprises a plurality of titanium dioxide particles, and an organic treating agent deposited on the surfaces of the titanium dioxide particles and forming a coating of the organic treating agent thereon. The organic treating agent includes a first component consisting of at least one polyhydric alcohol, and a second component selected from the group consisting of carboxylic acids and salts thereof, alkanolamines, and combinations thereof.

For example, the titanium dioxide particles can be titanium dioxide particles that have been produced by the sulfate process. For example, the titanium dioxide particles can be titanium dioxide particles that have been produced by the chloride process. The titanium dioxide particles can have a rutile crystalline structure, an anatase crystalline structure, or a combination thereof. For example, the titanium dioxide particles can have a rutile crystalline structure. For example, the titanium dioxide particles can have an anatase crystalline structure.

For example, the organic treating agent can be deposited on the surfaces of the pigment particles in an amount in the range of from about 0.1% to about 1% by weight, based on the weight of the titanium dioxide particles. For example, the organic treating agent can be deposited on the surfaces of the pigment particles in an amount in the range of from about 0.2% to about 0.9% by weight, based on the weight of the titanium dioxide particles. For example, the organic treating agent can be deposited on the surfaces of the pigment particles in an amount in the range of from about 0.4% to about 0.7% by weight, based on the weight of the titanium dioxide particles.

For example, the ratio of the first component to the second component in the organic treating agent can be in the range of from about 1:1 to about 20:1. For example, the ratio of the first component to the second component in the organic treating agent can be in the range of from about 2:1 to about 10:1. For example, the ratio of the first component to the second component in the organic treating agent can be in the range of from about 3:1 to about 7:1. For example, the ratio of the first component to the second component in the organic treating agent can be about 5:1.

For example, the polyhydric alcohol(s) of the first component of the organic treating agent can be selected from the group consisting of glycerol, polyglycerol, mannitol, xylitol, erythritol, and combinations thereof. For example, the polyhydric alcohol(s) of the first component of the organic treating agent can be selected from the group consisting of glycerol, xylitol, erythritol, and combinations thereof. For example, the polyhydric alcohol(s) of the first component of the organic treating agent can be selected from the group consisting of glycerol, xylitol, and combinations thereof.

For example, the first component of the organic treating agent can be deposited on the surfaces of the pigment particles in an amount in the range of from about 0.1% to about 1% by weight, based on the weight of the titanium dioxide particles. For example, the first component of the organic treating agent can be deposited on the surfaces of the pigment particles in an amount in the range of from about 0.2% to about 0.9% by weight, based on the weight of the titanium dioxide particles. For example, the first component of the organic treating agent can be deposited on the surfaces of the pigment particles in an amount in the range of from about 0.4% to about 0.7% by weight, based on the weight of the titanium dioxide particles.

For example, the second component of the organic treating agent can be at least one carboxylic acid and/or salt thereof. The carboxylic acid(s) and/or salt(s) thereof can be selected from the group consisting of monocarboxylic acids, dicarboxylic acids, hydroxyl carboxylic acids, salts of monocarboxylic acids, salts of dicarboxylic acids, salts of hydroxyl carboxylic acids, and combinations thereof. For example, the carboxylic acid(s) and/or salt(s) thereof can be selected from the group consisting of benzoic acid, adipic acid, propionic acid, citric acid, lactic acid, tartaric acid, salts of benzoic acid, salts of adipic acid, salts of propionic acid, salts of citric acid, salts of lactic acid, salts of tartaric acid, and combinations thereof. For example, the carboxylic acid(s) and/or salt(s) thereof can be selected from the group consisting of benzoic acid, citric acid, lactic acid, salts of benzoic acid, salts of citric acid, salts of lactic acid, and combinations thereof. For example, the carboxylic acid(s) and/or salt(s) thereof can be selected can be selected from the group consisting of benzoic acid, lactic acid, salts of benzoic acid, salts of lactic acid, and combinations thereof. For example, the carboxylic acid(s) and/or salt(s) thereof can be selected from the group of benzoic acid and salts thereof.

For example, the second component of the organic treating agent can be at least one the alkanolamine. For example, the alkanolamine(s) can be selected can be selected from the group consisting of hydroxylamines, triisopropanolamine (TIPA), triethanolamine (TEOA), tris(hydroxymethyl)aminomethane, and combinations thereof. For example, the alkanolamine(s) can be selected can be selected from the group consisting of triisopropanolamine (TIPA), triethanolamine (TEOA), and combinations thereof. For example, the alkanolamine(s) can be a triisopropanolamine (TIPA).

For example, the second component of the organic treating agent can be at least one carboxylic acid salt and/or salt thereof together with one or more alkanolamines. For example, the carboxylic acid(s) and/or salt(s) thereof can be selected from a group as set forth above. For example, the alkanolamine(s) can be selected from a group as set forth above.

For example, the second component of the organic treating agent can be deposited on the surfaces of the pigment particles in an amount in the range of from about 0.01% to about 0.8% by weight, based on the weight of the titanium dioxide particles. For example, the second component of the organic treating agent can be deposited on the surfaces of the pigment particles in an amount in the range of from about 0.03% to about 0.5% by weight, based on the weight of the titanium dioxide particles. For example, the second component of the organic treating agent can be deposited on the surfaces of the pigment particles in an amount in the range of from about 0.05% to about 0.4% by weight, based on the weight of the titanium dioxide particles.

For example, if the second component of the organic treating agent is one or more carboxylic acids or salts thereof, it can be deposited on the surfaces of the pigment particles in an amount in the range of from about 0.1% to about 0.6% by weight, based on the weight of the titanium dioxide particles. For example, if the second component of the organic treating agent is one or more carboxylic acids or salts thereof, it can be deposited on the surfaces of the pigment particles in an amount in the range of from about 0.15% to about 0.5% by weight, based on the weight of the titanium dioxide particles. For example, if the second component of the organic treating agent is one or more carboxylic acids or salts thereof, it can be deposited on the surfaces of the pigment particles in an amount in the range of from about 0.2% to about 0.4% by weight, based on the weight of the titanium dioxide particles.

For example, if the second component of the organic treating agent is one or more alkanolamines, it can be deposited on the surfaces of the pigment particles in an amount in the range of from about 0.01% to about 0.2% by weight, based on the weight of the titanium dioxide particles. For example, if the second component of the organic treating agent is one or more alkanolamines, it can be deposited on the surfaces of the pigment particles in an amount in the range of from about 0.02% to about 0.16% by weight, based on the weight of the titanium dioxide particles. For example, if the second component of the organic treating agent is one or more alkanolamines, it can be deposited on the surfaces of the pigment particles in an amount in the range of from about 0.04% to about 0.12% by weight, based on the weight of the titanium dioxide particles.

In one embodiment, the treated titanium dioxide further comprises an inorganic treating agent deposited on the surfaces of the titanium dioxide particles and forming a coating of the inorganic treating agent thereon. For example, the organic treating agent can be deposited on top of the coating of the inorganic treating agent.

For example, a first inorganic treating agent can be deposited on the surfaces of the titanium dioxide particles to form a coating of the first inorganic treating agent thereon, and a second inorganic treating agent can be deposited on top of the coating of the first inorganic treating agent to form a coating of the second inorganic treating agent thereon. For example, the organic treating agent can be deposited on top of the coating of the second inorganic treating agent.

The inorganic treating agent(s) can be the inorganic treating agent(s) described above in connection with the process disclosed herein. For example, the inorganic treating agent(s) is deposited on the surfaces of the titanium dioxide particles in an amount in the range of about 0.1% by weight to about 15% by weight, based on the combined weight of the titanium dioxide particles and the inorganic coating(s). For example, the inorganic treating agent(s) is deposited on the surfaces of the titanium dioxide particles in an amount in the range of about 0.5% by weight to about 10% by weight, based on the weight of the titanium dioxide particles.

For example, in one embodiment, the organic treating agent referenced above is a second organic treating agent, and the treated titanium dioxide pigment further comprises a first organic treating agent deposited on the surfaces of the pigment particles to form a coating of the first organic treating agent thereon. For example, the second organic treating agent can be deposited on top of the first organic treating agent.

For example, the first organic treating agent can be selected from the group consisting of alkyl phosphinic acids, derivatives of alkyl phosphinic acids, phosphonic acids, derivatives of phosphonic acids, siloxanes, and combinations thereof.

Examples of alkyl phosphinic acids and derivatives of alkyl phosphinc acids that can be used include bis(2,4,4,-trimethylpentyl) phosphinic acid, bis (2-ethylhexyl phosphinic acid), oleyl phosphinic acid, n-octadecyl phosphinic acid, esters of phosphinic acids, and combinations thereof. An example of an ester of a phosphinic acid that can be used is bis(2-ethylhexyl)phosphinic acid 2-ethylhexyl ester.

Examples of phosphonic acids and derivatives of phosphonic acids that can be used include n-octylphosphonic acid, decylphosphonic acid, dodecylphosphonic acid, octylphosphonic acid, esters of phosphonic acids, salts of phosphonic acids, and combinations thereof. Examples of esters of phosphonic acids that can be used include esters of alkylphosphonic acids. An example of a salt of a phosphonic acid that can be used is monoethyl ester potassium salt.

Examples of siloxanes that can be used include polydimethyl siloxane, copolymers of polydimethyl siloxane and polymethyl hydrogen siloxane, n-octyltriethoxy silane, silicone alkylpolyethers, silicone polyether carboxylates, and combinations thereof.

For example, the first organic treating agent can be selected from the group consisting of alkyl phosphinic acids, phosphonic acids, siloxanes, and combinations thereof. For example, the first organic treating agent can consist of one or more alkyl phosphinic acids. For example, the first organic treating agent can be bis(2,4,4,-trimethylpentyl) phosphinic acid.

For example, the first organic treating agent can be deposited on the surfaces of the pigment particles in an amount in the range of from about 0.05% to about 1.0% by weight, based on the weight of the titanium dioxide particles. For example, the organic treating agent can be deposited on the surfaces of the pigment particles in an amount in the range of from about 0.1% to about 0.8% by weight, based on the weight of the titanium dioxide particles. For example, the organic treating agent can be deposited on the surfaces of the pigment particles in an amount in the range of from about 0.2% to about 0.6% by weight, based on the weight of the titanium dioxide particles.

The treated titanium dioxide can be formed by the process disclosed herein.

For example, in one embodiment, the process disclosed herein comprises: providing a plurality of titanium dioxide pigment particles; and depositing an organic treating agent on the surfaces of the pigment particles to form a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component selected from the group consisting of carboxylic acids and salts thereof, alkanolamines, and combinations thereof, wherein the ratio of the first component to the second component in the treating agent is in the range of from about 1:1 to about 20:1.

For example, in another embodiment, the process disclosed herein comprises: providing a plurality of titanium dioxide pigment particles; and depositing an organic treating agent on the surfaces of the pigment particles to form a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component selected from the group consisting of carboxylic acids and salts thereof, wherein the carboxylic acid and/or salt thereof is selected from the group consisting of benzoic acid, adipic acid, propionic acid, citric acid, lactic acid, tartaric acid, salts of benzoic acid, salts of adipic acid, salts of propionic acid, salts of citric acid, salts of lactic acid, salts of tartaric acid, and combinations thereof.

For example, in another embodiment, the process disclosed herein comprises: providing a plurality of titanium dioxide pigment particles; and depositing an organic treating agent on the surfaces of the pigment particles to form a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component selected from the group consisting of carboxylic acids and salts thereof, wherein the carboxylic acid and/or salt thereof is selected from the group consisting of benzoic acid and salts thereof.

For example, in another embodiment, the process disclosed herein comprises: providing a plurality of titanium dioxide pigment particles; and depositing an organic treating agent on the surfaces of the pigment particles to form a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component, wherein the second component is at least one alkanolamine.

For example, in another embodiment, the process disclosed herein comprises: providing a plurality of titanium dioxide pigment particles; and depositing an organic treating agent on the surfaces of the pigment particles to form a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component, wherein the second component is an alkanolamine selected from the group consisting of hydroxylamines, triisopropanolamine (TIPA), triethanolamine (TEOA), tris(hydroxymethyl)aminomethane, and combinations thereof.

For example, in another embodiment, the process disclosed herein comprises: providing a plurality of titanium dioxide pigment particles; and depositing an organic treating agent on the surfaces of the pigment particles to form a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component, wherein the second component is an alkanolamine, wherein the alkanolamine is a triisopropanolamine (TIPA).

For example, in one embodiment, the process disclosed herein comprises: providing a plurality of titanium dioxide pigment particles; depositing a first organic treating agent on the surfaces of the pigment particles to form a coating of the first organic treating agent thereon; and depositing a second organic treating agent on the surfaces of the pigment particles to form a coating of the organic treating agent thereon. In this embodiment, the second organic treating agent includes: a first component consisting of at least one polyhydric alcohol, and a second component selected from the group consisting of carboxylic acids and salts thereof, alkanolamines, and combinations thereof.

For example, in another embodiment, the process disclosed herein comprises: providing a plurality of titanium dioxide pigment particles; depositing a first organic treating agent on the surfaces of the pigment particles to form a coating of the first organic treating agent thereon; and depositing a second organic treating agent on the surfaces of the pigment particles to form a coating of the organic treating agent thereon. In this embodiment, the first organic treating agent is selected from the group consisting of alkyl phosphinic acids, derivatives of alkyl phosphinic acids, phosphonic acids, derivatives of phosphonic acids, siloxanes, and combinations thereof. The second organic treating agent includes: a first component consisting of at least one polyhydric alcohol, and a second component selected from the group consisting of carboxylic acids and salts thereof, alkanolamines, and combinations thereof.

For example, in another embodiment, the process disclosed herein comprises: providing a plurality of titanium dioxide pigment particles; depositing a first organic treating agent on the surfaces of the pigment particles to form a coating of the first organic treating agent thereon; and depositing a second organic treating agent on the surfaces of the pigment particles to form a coating of the organic treating agent thereon. In this embodiment, the first organic treating agent is selected from the group consisting of alkyl phosphinic acids, phosphonic acids, siloxanes, and combinations thereof. The second organic treating agent includes: a first component consisting of at least one polyhydric alcohol, and a second component selected from the group consisting of carboxylic acids and salts thereof, alkanolamines, and combinations thereof.

For example, in another embodiment, the process disclosed herein comprises: providing a plurality of titanium dioxide pigment particles; depositing a first organic treating agent on the surfaces of the pigment particles to form a coating of the first organic treating agent thereon; and depositing a second organic treating agent on the surfaces of the pigment particles to form a coating of the organic treating agent thereon. In this embodiment, the first organic treating agent consists of one or more alkyl phosphinic acids. The second organic treating agent includes: a first component consisting of at least one polyhydric alcohol, and a second component selected from the group consisting of carboxylic acids and salts thereof, alkanolamines, and combinations thereof.

For example, in another embodiment, the process disclosed herein comprises: providing a plurality of titanium dioxide pigment particles; depositing a first organic treating agent on the surfaces of the pigment particles to form a coating of the first organic treating agent thereon; and depositing a second organic treating agent on the surfaces of the pigment particles to form a coating of the organic treating agent thereon. In this embodiment, the first organic treating agent is bis(2,4,4,-trimethylpentyl) phosphinic acid. The second organic treating agent includes: a first component consisting of at least one polyhydric alcohol, and a second component selected from the group consisting of carboxylic acids and salts thereof, alkanolamines, and combinations thereof.

For in one embodiment, the treated, titanium dioxide pigment comprises: a plurality of titanium dioxide pigment particles; and an organic treating agent deposited on the surfaces of the titanium dioxide pigment particles and forming a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component selected from the group consisting of carboxylic acids and salts thereof, alkanolamines, and combinations thereof, wherein the ratio of the first component to the second component in the treating agent is in the range of from about 1:1 to about 20:1.

For in one embodiment, the treated, titanium dioxide pigment comprises: a plurality of titanium dioxide pigment particles; and an organic treating agent deposited on the surfaces of the titanium dioxide pigment particles and forming a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component selected from the group consisting of carboxylic acids and salts thereof, wherein the carboxylic acid and/or salt thereof is selected from the group consisting of benzoic acid, adipic acid, propionic acid, citric acid, lactic acid, tartaric acid, salts of benzoic acid, salts of adipic acid, salts of propionic acid, salts of citric acid, salts of lactic acid, salts of tartaric acid, and combinations thereof.

For in one embodiment, the treated, titanium dioxide pigment comprises: a plurality of titanium dioxide pigment particles; and an organic treating agent deposited on the surfaces of the titanium dioxide pigment particles and forming a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component selected from the group consisting of carboxylic acids and salts thereof, wherein the carboxylic acid and/or salt thereof is selected from the group consisting of benzoic acid and salts thereof.

For in one embodiment, the treated, titanium dioxide pigment comprises: a plurality of titanium dioxide pigment particles; and an organic treating agent deposited on the surfaces of the titanium dioxide pigment particles and forming a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component, wherein the second component is at least one alkanolamine.

For in one embodiment, the treated, titanium dioxide pigment comprises: a plurality of titanium dioxide pigment particles; and an organic treating agent deposited on the surfaces of the titanium dioxide pigment particles and forming a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component, wherein the second component is an alkanolamine selected from the group consisting of hydroxylamines, triisopropanolamine (TIPA), triethanolamine (TEOA), tris(hydroxymethyl)aminomethane, and combinations thereof.

For in one embodiment, the treated, titanium dioxide pigment comprises: a plurality of titanium dioxide pigment particles; and an organic treating agent deposited on the surfaces of the titanium dioxide pigment particles and forming a coating of the organic treating agent thereon. In this embodiment, the organic treating agent includes: a first component consisting of at least one polyhydric alcohol selected from the group consisting of glycerol, polyglycerol, mannitol, xylitol, erythritol, and combinations thereof; and a second component, wherein the second component is an alkanolamine, wherein the alkanolamine is a triisopropanolamine (TIPA).

For example, in another embodiment, the treated, titanium dioxide pigment disclosed herein comprises: a plurality of titanium dioxide pigment particles; a first organic treating agent deposited on the surfaces of the pigment particles to form a coating of the first organic treating agent thereon; and a second organic treating agent deposited on the surfaces of the pigment particles to form a coating of the organic treating agent thereon. In this embodiment, the first organic treating agent is selected from the group consisting of alkyl phosphinic acids, derivatives of alkyl phosphinic acids, phosphonic acids, derivatives of phosphonic acids, siloxanes, and combinations thereof. The second organic treating agent includes: a first component consisting of at least one polyhydric alcohol, and a second component selected from the group consisting of carboxylic acids and salts thereof, alkanolamines, and combinations thereof.

For example, in another embodiment, the treated, titanium dioxide pigment disclosed herein comprises: a plurality of titanium dioxide pigment particles; a first organic treating agent deposited on the surfaces of the pigment particles to form a coating of the first organic treating agent thereon; and a second organic treating agent deposited on the surfaces of the pigment particles to form a coating of the organic treating agent thereon. In this embodiment, the first organic treating agent is selected from the group consisting of alkyl phosphinic acids, phosphonic acids, siloxanes, and combinations thereof. The second organic treating agent includes: a first component consisting of at least one polyhydric alcohol, and a second component selected from the group consisting of carboxylic acids and salts thereof, alkanolamines, and combinations thereof.

For example, in another embodiment, the treated, titanium dioxide pigment disclosed herein comprises: a plurality of titanium dioxide pigment particles; a first organic treating agent deposited on the surfaces of the pigment particles to form a coating of the first organic treating agent thereon; and a second organic treating agent deposited on the surfaces of the pigment particles to form a coating of the organic treating agent thereon. In this embodiment, the first organic treating agent consists of one or more alkyl phosphinic acids. The second organic treating agent includes: a first component consisting of at least one polyhydric alcohol, and a second component selected from the group consisting of carboxylic acids and salts thereof, alkanolamines, and combinations thereof.

For example, in another embodiment, the treated, titanium dioxide pigment disclosed herein comprises: a plurality of titanium dioxide pigment particles; a first organic treating agent deposited on the surfaces of the pigment particles to form a coating of the first organic treating agent thereon; and a second organic treating agent deposited on the surfaces of the pigment particles to form a coating of the organic treating agent thereon. In this embodiment, the first organic treating agent is bis(2,4,4,-trimethylpentyl) phosphinic acid. The second organic treating agent includes: a first component consisting of at least one polyhydric alcohol, and a second component selected from the group consisting of carboxylic acids and salts thereof, alkanolamines, and combinations thereof.

The organic treating agent deposited on the surfaces of the titanium dioxide pigment particles in accordance with the process disclosed herein and in connection with the titanium dioxide pigment disclosed herein effectively serves as a grinding aid in the milling process, improves the flow and dispersion properties of the pigment and otherwise improves the performance of the pigment. As a result, the organic treating agent can provide an effective substitute for TMP in connection with the production of titanium dioxide pigments and produced titanium dioxide pigments.

### Illustrative Examples

The treated titanium dioxide pigment formed by the process disclosed herein and the treated titanium dioxide pigment disclosed herein are exemplified by the following examples.

### Treatment Example 1. Preparation of Silica and Alumina Treated Titanium Dioxide Filter Cake

Particulate titanium dioxide pigment particles formed by the chloride process were dispersed in water in the presence of 0.075% of sodium hexametaphosphate dispersant, along with a sufficient amount of sodium hydroxide to adjust the pH of the dispersion to 9.5 or higher to achieve an aqueous dispersion with a solids content of 35%. The resulting slurry was subjected to sand milling (using a zircon sand-to-pigment weight ratio of 4:1) until 94% of the particles were smaller than 0.63 microns, as determined by a Microtrac X 100 Particle Size Analyzer.

The resulting slurry, diluted to a 30% solids content, was heated to 75° C. and subsequently treated with 3.0% of sodium silicate (calculated as silica by weight of the final pigment) by adding the sodium silicate to the slurry over 20 minutes. While maintaining the temperature at 75° C., the pH of the slurry was slowly decreased to 5.5 over a 55-minute period via the slow addition of concentrated sulfuric acid. After allowing the slurry to digest for 15 minutes, 1.6% of sodium aluminate (calculated as alumina by weight of the final pigment), was added to the slurry over 10 minutes. The pH of the slurry was maintained between 8.25 and 9.25 via the concomitant addition of concentrated sulfuric acid. The slurry was allowed to digest for 15 minutes at 75° C., and the pH of the slurry was then adjusted to 6.2 with concentrated sulfuric acid. The slurry was then filtered while hot. The resulting filtrate was washed with water, which had been preheated to 60° C. A wet titanium dioxide filter cake treated with silica and alumina was obtained.

### Treatment Example 2. Preparation of Zirconia and Alumina Treated Titanium Dioxide Filter Cake

Particulate titanium dioxide pigment particles formed by the chloride process were dispersed in water in the presence of 0.075% of sodium hexametaphosphate dispersant, along with a sufficient amount of sodium hydroxide to adjust the pH of the dispersion to 9.5 or higher to achieve an aqueous dispersion with a solids content of 35%. The resulted slurry was subjected to sand milling (using a zircon sand-to-pigment weight ratio of 4:1) until 92% of the particles were smaller than 0.63 microns, as determined by Microtrac X 100 Particle Size Analyzer.

The resulting slurry, diluted to a 30% solids content, was heated to 70° C., and the pH was adjusted to 3.5 with concentrated sulfuric acid. The slurry was then treated with 0.25% of zirconium oxychloride (calculated as zirconia by weight of final pigment) by adding the zirconium oxychloride to the slurry. After allowing the slurry to digest for 15 minutes, 3.0% of sodium aluminate (calculated as alumina by weight of the final pigment) was added to the slurry over 20 minutes. The pH of the slurry was maintained between 8 and 8.5 via the concomitant addition of concentrated sulfuric acid. The slurry was then digested for 15 minutes at 70° C., and the pH of the slurry was then adjusted to 7.5 with concentrated sulfuric acid. The slurry was then filtered while hot. The resulting filtrate was washed with water, which had been preheated to 60° C. A wet titanium dioxide filter cake treated with zirconia and alumina was obtained.

### Comparative Example 1. Pigment Preparation with TMP

The wet titanium dioxide filter cake from Treatment Example 1 in an amount equal to 1000 g of dry pigment was mixed with deionized water to provide a 50% slurry. Next, 10.61 g of a 33% trimethylolpropane (TMP) aqueous solution was added to the slurry and mixed well therewith. The TMP treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Comparative Example 2. Pigment Preparation with Glycerol

The wet titanium dioxide filter cake from Treatment Example 1 in an amount equal to 1000 g of dry pigment was mixed with deionized water to provide a 50% slurry. Next, 5.0 g of glycerol was added to the slurry and mixed well therewith. The glycerol treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Comparative Example 3. Pigment Preparation with Glycerol

The wet titanium dioxide filter cake from Treatment Example 1 in an amount equal to 1000 g of dry pigment was mixed with deionized water to provide a 50% slurry. Next, 7.0 g of glycerol was added to the slurry and mixed well therewith. The glycerol treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Claimed Pigment Example 1. Pigment Preparation with Glycerol and Sodium Benzoate

The wet titanium dioxide filter cake from Treatment Example 1 in an amount equal to 1000 g of dry pigment was mixed with deionized water to provide a 50% slurry. Next, 3.5 g of sodium benzoate was dissolved in 10 g of deionized water, and then mixed with 3.5 g of glycerol to provide a chemical mixture. The chemical mixture was then mixed with the titanium dioxide slurry. The treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Comparative Example 4. Pigment Preparation with TMP

The wet titanium dioxide filter cake from Treatment Example 2 in an amount equal to 1000 g of dry pigment was mixed with deionized water to provide a 50% slurry. Next, 10.61 g of a 33% trimethylolpropane (TMP) aqueous solution was added to the slurry and mixed well therewith. The TMP treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by Microtrac X 100 Particle Size Analyzer and reported as % Pass at 0.63 microns.

### Comparative Example 5. Pigment Preparation with Glycerol

The wet titanium dioxide filter cake from Treatment Example 2 in an amount equal to 1000 g of dry pigment was mixed with deionized water to provide a 50% slurry. Next, 5.0 g of glycerol was added to the slurry and mixed well therewith. The glycerol treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Comparative Example 6. Pigment Preparation with Glycerol

The wet titanium dioxide filter cake from Treatment Example 2 in an amount equal to 1000 g of dry pigment was mixed with deionized water to provide a 50% slurry. Next, 8.0 g of glycerol was added to the slurry and mixed well therewith. The glycerol treated titanium dioxide slurry was then dried in oven at 115° C. to a moisture content less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Comparative Example 7. Pigment Preparation with TIPA

The wet titanium dioxide filter cake from Treatment Example 2 in an amount equal to 1000 g of dry pigment was mixed with deionized water to provide a 50% slurry. Next, 5.9 g of an 85% triisopropanolamine (TIPA) solution was added to the slurry and mixed well therewith. The TIPA treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Claimed Pigment Example 2. Pigment Preparation with Glycerol and Triisopropanolamine (TIPA)

The wet titanium dioxide filter cake from Treatment Example 2 in an amount equal to 1000 g of dry pigment was mixed with deionized water to provide a 50% slurry. Next, 1.2 g of an 85% TIPA solution was mixed with 5.0 g of glycerol in 5.0 g deionized water to provide a chemical mixture. The chemical mixture was then mixed with the titanium dioxide slurry. The treated titanium dioxide slurry was then dried in an oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Testing Example 1: Paint Gloss and Tint Strength Tests in Waterborne Acrylic Paint Formulation

In each test, a sample and a standard were prepared in identical formulations as shown by Table 1. Both paints were then drawn down side by side on a Leneta card. The gloss of the dried films was measured from reflected light at a sixty-degree angle using a gloss meter. The CIE L* and b* values of the dried paint were measured using an integrating sphere spectrophotometer, and these values were used to calculate the tint strength and tint tone.

TABLE 1
Waterborne acrylic coating formulation used
for gloss and tint strength testing

| Material | Weight (g) |
|---|---|
| Mill base | |
| Deionized water | 51.1 |
| Defoamer | 1.2 |
| Dispersant | 12 |
| Nonionic surfactant | 6.3 |
| Propylene glycol | 30 |
| Coalescent | 11.2 |
| TiO2 dry pigment | 298.7 |
| Deionized water | 18.7 |
| Letdown | |
| Rhoplex AC-2508 (46.5%) | 612.5 |
| Defoamer | 1.5 |
| Cellulosic thickener | 1.3 |
| Coalescent | 17 |
| Ammonium hydroxide | 1.5 |
| Biocide | 0.5 |
| Deionized water | 49.7 |

Tinted with 8 g of Colortrend 888 carbon black.

Tint strength was calculated using the Kubelka Munk Equation where:

$$Tint Strength = ( \frac{{( \frac{K}{S} )}_{Standard}}{{( \frac{K}{S} )}_{Sample}} ) ( Assigned Value )$$

where: K=Absorbance of carbon black pigment
   S=Scatter of titanium dioxide pigment
Tint Tone was calculated as follows:

$$Tint Tone = \text{?} - \text{?} + Assigned Value$$

$$\text{?} \text{indicates text missing or illegible when filed}$$

### Testing Example 2: Pigment Alkyd Dispersion Test

A solvent-borne alkyd paint was made as shown in Table 2. The paint was drawn down on a Hegman gauge. The alkyd dispersion fineness (grinding line in the unit of microns) was determined, and the alkyd dispersion cleanliness (nibs count) were read as the number of nibs above the grinding line.

TABLE 2
Solvent-borne alkyd coating formulation
used for pigment alkyd dispersion testing

| Material | Weight (g) |
|---|---|
| Mill base | |
| Alkyd resin | 74.3 |
| Organic solvent | 25.7 |
| TiO2 dry pigment | 300 |
| Letdown | |
| Alkyd resin | 35 |
| Organic solvent | 30 |

The paint testing results of the titanium dioxide finished pigments described in the examples set forth above are listed in Table 3 and Table 4 below.

TABLE 3
Paint testing results of silica and alumina treated TiO2

| | Comparative | Comparative | Comparative | Claimed Pigment |
|---|---|---|---|---|
| | Example 1 | Example 2 | Example 3 | Example 1 |
| % Organic | 0.35% TMP | 0.5% glycerol | 0.7% glycerol | 0.35% glycerol, |
| chemical on TiO2 | | | | 0.35% sodium |
| | | | | benzoate |
| Microtrac % pass | 90.7 | 87.5 | 87.3 | 90.2 |
| @ 0.63 nm | | | | |
| WB gloss | 57 | 47 | 49 | 59 |
| WB tint strength | 105 | 104 | 104 | 106 |
| Alkyd dispersion | 8 | 43 | 29 | 10 |
| Fineness | | | | |
| Alkyd dispersion | 5 | 16 | 14 | 10 |
| cleanliness, Nibs | | | | |

TABLE 4
Paint testing results of zirconia and alumina treated TiO2

| | | | | | Claimed |
|---|---|---|---|---|---|
| | Comparative | Comparative | Comparative | Comparative | Pigment |
| | Example 4 | Example 5 | Example 6 | Example 7 | Example 2 |
| % Organic | 0.35% TMP | 0.5% glycerol | 0.8% glycerol | 0.5% TIPA | 0.5% glycerol, |
| chemical on TiO2 | | | | | 0.1% TIPA |
| Microtrac % pass | 91.3 | 88.4 | 87.7 | 93.3 | 91.0 |
| @ 0.63 nm | | | | | |
| WB gloss | 65 | 59 | 58 | 72 | 64 |
| WB tint strength | 108 | 104 | 103 | 108 | 107 |
| Alkyd dispersion | 1 | 7 | 7 | 46 | 1 |
| cleanliness | | | | | |
| Alkyd dispersion | 3 | 3 | 6 | 23 | 2 |
| Fineness, Nibs | | | | | |

As shown by Tables 3 and 4, in the samples prepared with only glycerol, the particle size distribution was larger, the gloss and tint strength were lower, and the alkyd dispersion was worse than the standard control with TMP. On the other hand, in the samples prepared with glycerol and sodium benzoate (Claimed Pigment Example 1), and glycerol and TIPA (Claimed Pigment Example 2), comparable results to the standard control were obtained.

As stated above, a TMP consortium associated with the Registration, Evaluation, Authorization and Restriction of Chemicals (REACH) regulation of the European Union has self-classified TMP as a suspected reproductive toxicant. On the other hand, the organic chemicals used in forming Claimed Pigment Examples 1 and 2 are either direct food additives (glycerol and sodium benzoate) or considered as safe in indirect food contact (TIPA).

### Treatment Example 3. Preparation of Alumina Treated Titanium Dioxide Filter Cake

Particulate titanium dioxide pigment particles formed by the chloride process were dispersed in water in the presence of 0.1% of sodium hexametaphosphate dispersant, along with a sufficient amount of sodium hydroxide to adjust the pH of the dispersion to 9.5 or higher to achieve an aqueous dispersion with a solids content of 35%. The resulted slurry was subjected to sand milling (using a zircon sand-to-pigment weight ratio of 4:1) until 90% of the particles were smaller than 0.63 microns, as determined by a Microtrac X 100 Particle Size Analyzer.

The resulting slurry, diluted to a 30% solids content, was heated to 60° C. The pH of the slurry was then adjusted to 2.0 with concentrated sulfuric acid, and 1.0% of sodium aluminate (calculated as alumina by weight of final pigment) was added to the slurry. After allowing the slurry to digest for 15 minutes, the pH of the slurry was adjusted to 6.0 with concentrated sulfuric acid. The slurry was then filtered while hot. The resulting filtrate was washed with water, which had been preheated to 60° C. A wet titanium dioxide filter cake treated with alumina was obtained.

### Comparative Example 8. Pigment Prepared with TMP

The wet titanium dioxide filter cake from Treatment Example 3 in an amount equal to 1000 g dry pigment was mixed with deionized water to obtain a 50% slurry. Next, 10.61 g of a 33% trimethylolpropane (TMP) aqueous solution was added to the slurry and mixed well therewith. The TMP treated titanium dioxide slurry was then dried in oven at 115° C. to a moisture content of less than 1%. The dried pigment was crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Comparative Example 9. Pigment Preparation with Glycerol

The wet titanium dioxide filter cake from Treatment Example 9 in an amount equal to 1000 g dry pigment was mixed with deionized water to provide a 50% slurry. Next, 5.0 g of glycerol was added to the slurry and mixed well therewith. The glycerol treated titanium dioxide slurry was then dried in oven at 115° C. to a moisture content of less than 1%. The dried pigment was crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Claimed Pigment Example 3. Pigment Preparation with Glycerol and Triisopropanolamine (TIPA)

The wet titanium dioxide filter cake from Treatment Example 3 in an amount equal to 1000 g dry pigment was mixed with deionized water to provide a 50% slurry. Next, 0.59 g of an 85% TIPA solution was mixed with 5.5 g of glycerol in 5.0 g deionized water to provide a chemical mixture. The chemical mixture was then mixed with the titanium dioxide slurry. The treated titanium dioxide slurry was then dried in oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Claimed Pigment Example 4. Pigment Preparation with Glycerol and Triisopropanolamine (TIPA)

The wet titanium dioxide filter cake from Treatment Example 3 in an amount equal to 1000 g dry pigment was mixed with deionized water to provide a 50% slurry. Next, 1.18 g of an 85% TIPA solution was mixed with 5.0 g of glycerol in 5.0 g deionized water to provide a chemical mixture. The chemical mixture was mixed with the titanium dioxide slurry. The treated titanium dioxide slurry was then dried in oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Claimed Pigment Example 5. Pigment Preparation with Glycerol and Triisopropanolamine (TIPA)

The wet titanium dioxide filter cake from Treatment Example 3 in an amount equal to 1000 g dry pigment was mixed with deionized water to provide a 50% slurry. Next, 1.76 g of an 85% TIPA solution was mixed with 4.5 g of glycerol in 5.0 g deionized water to provide a chemical mixture. The chemical mixture was then mixed with the titanium dioxide slurry. The treated titanium dioxide slurry was then dried in oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Claimed Pigment Example 6. Pigment Preparation with Glycerol and Triisopropanolamine (TIPA) (High TIPA Dosage)

The wet titanium dioxide filter cake from Treatment Example 3 in an amount equal to 1000 g dry pigment was mixed with deionized water to provide a 50% slurry. Next, 2.35 g of an 85% TIPA solution was mixed with 4.0 g of glycerol in 5.0 g deionized water to obtain a chemical mixture. The chemical mixture was then mixed with the titanium dioxide slurry. The treated titanium dioxide slurry was then dried in oven at 115° C. to a moisture content of less than 1%. The dried pigment was then crushed to yield a dry pigment powder. The dry pigment powder was then steam micronized utilizing a steam to pigment weight ratio of 1.8:1 with the steam injector pressure set at 160 psi and the micronizer ring pressure set at 118 psi. The particle size distribution of the finished pigment was determined by a Microtrac X 100 Particle Size Analyzer and reported as % Pass at 0.63 microns.

### Testing Example 3: Plastic Optical Testing in Low Density Polyethylene (LDPE)

In each test, a Brabender mixing bowl fitted with cam blades was heated to 100° C. Next, 55.0 g of a black concentrate, 0.5 g of zinc stearate, 0.4 g of a polymeric processing additive (BYK P-4102), and 2.50 g of the titanium dioxide pigment sample being tested were placed into a cup. The Brabender mixing bowl was started and the contents of the cup were poured into the bowl using a chute and ram. A weight was used to hold the ram down for approximately 2 minutes to allow the sample to fuse. The chute and ram were removed and the cover of the Brabender bowl was closed to allow mixing of the contents to continue for 6 minutes. The plastic mixture was then removed from the Brabender bowl and placed between ferro plates inside a mold. The mold was immediately pressed for 1 minute at 10,000 psi. The sample was then cooled and removed from the mold. The L*, at, and b* were read and the tint strength and tint tone were calculated based on a test standard that was run with each batch.

The results of these tests of Comparative Examples 8 and 9 and Claimed Pigment Examples 3-6 as described above are shown in Table 5 below.

### Testing Example 4: Plastic Equilibrium Torque and Screen Pack Testing in Linear Low Density Polyethylene (LLDPE)

Additional tests were carried out on Comparative Examples 8 and 9 and Claimed Pigment Examples 3-6 as described above.

First, in each test, 109.5 g of the treated pigment to be tested were mixed with 36.5 g of linear low density polyethylene (LLDPE) (DOW 9820) to prepare a 75% by weight titanium dioxide-containing LLDPE concentrate. The components were thoroughly mixed together by masticating the components in the mixing bowl of a ATR Plasti-Corder (C. W. Brabender Instruments, Inc.) operating at 100° C. and a mixing speed of 100 rpm.

Instantaneous torque and temperature values were then recorded over a 9 minute period to ensure equilibrium mixing conditions were attained. Equilibrium torque values were determined via averaging the minimum measured instantaneous torque value over a 1 minute period before and a 1 minute period after the minimum mixing condition had been achieved.

Next, 100 g of the 75% concentrate were extruded through a 350 mesh screen filter using a 0.75 inch barrel and 25:1 length to diameter extruder attached to the aforementioned ATR Plasticorder, at an average processing temperature of approximately 190° C. and at 75 rpm. The amount of inorganic residue left on the 350 mesh screen filter, reported as pigment grit content in parts-per-million based on the amount of the pigment, was determined gravimetrically via heating the post-extrusion screen in a muffle furnace at 700° C. for ten minutes, cooling the screen to room temperature, and then subsequently weighing the screen, with comparison to its weight prior to use.

The results of these additional tests carried out on Comparative Examples 8 and 9 and Claimed Pigment Examples 3-6 are also shown in Table 5 below.

TABLE 5
Testing of alumina treated TiO2 and its application in plastics

| | Com- | Com- | | | | |
|---|---|---|---|---|---|---|
| | para- | para- | Claimed | Claimed | Claimed | Claimed |
| | tive | tive | Pigment | Pigment | Pigment | Pigment |
| | ex- | ex- | Ex- | Ex- | Ex- | Ex- |
| | ample | ample | ample | ample | ample | ample |
| | 8 | 9 | 3 | 4 | 5 | 6 |
| % Organic | 0.35% | 0.6% | 0.55% | 0.5% | 0.45% | 0.4% |
| chemical | TMP | Gly- | Gly- | Gly- | Gly- | Gly- |
| on TiO2 | | cerol | cerol, | cerol, | cerol, | cerol, |
| | | | 0.05% | 0.1% | 0.15% | 0.2% |
| | | | TIPA | TIPA | TIPA | TIPA |
| Microtrac, | 0.46 | 0.51 | 0.42 | 0.39 | 0.36 | 0.38 |
| Volume | | | | | | |
| average | | | | | | |
| (micron) | | | | | | |
| Microtrac, | 88.5 | 86.0 | 88.9 | 90.0 | 92.0 | 90.6 |
| 0.630% | | | | | | |
| Pass | | | | | | |
| LDTP Tint | 100 | 99 | 101 | 99 | 96 | 102 |
| strength | | | | | | |
| LDPE Tint | −5.3 | −5.3 | −5.3 | −5.3 | −5.5 | −5.5 |
| tone | | | | | | |
| LDPE | Normal | Normal | Normal | Normal | Normal | Sticky to |
| plastic | | | | | | equip- |
| application | | | | | | ment |
| observation | | | | | | blades |
| LLDPE | 1192 | 1209 | 1182 | 1161 | 1188 | 1412 |
| equilibrium | | | | | | |
| torque | | | | | | |
| (m-g) | | | | | | |
| LLDPE | 183 | 269 | 230 | 184 | 169 | 147 |
| screen | | | | | | |
| pack (ppm) | | | | | | |

As shown by Table 5, when only glycerol was used to replace TMP, the particles size of the alumina treated titanium dioxide was inferior to the TMP control, and the screen pack residue was also higher. As shown, 0.05% or higher of TIPA can significantly improve the grinding during micronizing and lead to a comparable particle size and screen pack residue as with the TMP control. It was noted that when the amount of TIPA used was 0.2% or higher, the material became very sticky to the equipment blades when applied in LDPE, and the equilibrium torque in LLDPE is also significantly higher, but the corresponding titanium dioxide pigment otherwise performed well overall.

### Treatment Example 4. Preparation of Phosphate and Alumina Treated Titanium Dioxide Filter Cake

Particulate titanium dioxide pigment particles formed by the chloride process were dispersed in water to form a raw slurry having a pH of 3-4. The resulting slurry was then subjected to sand milling (using a zircon sand-to-pigment weight ratio of 4:1) until 90% of the particles were smaller than 0.63 microns (as determined by a Microtrac X 100 Particle Size Analyzer) to achieve an aqueous dispersion with a solids content of 35%.

The resulting slurry, diluted to a 30% solids content, was then heated to 70° C. and the pH was adjusted to 1.0-1.5 with concentrated hydrochloric acid. Next, 0.4% of sodium hexametaphosphate (calculated as P2O5 by weight of final pigment) was added to the slurry. After allowing the slurry to digest for 5 minutes, 1.0% of sodium aluminate (calculated as alumina by weight of final pigment) was added to the slurry. After allowing the slurry to digest for 5 minutes, the pH of the slurry was then adjusted to 4.7 with a sodium hydroxide solution.

The slurry was then allowed to digest for 60 minutes and the pH of the slurry was adjusted to 6.4 with a sodium hydroxide solution. The slurry was then allowed to digest for another 10 minutes, and was then filtered while hot. The resulting filtrate was washed with water, which had been preheated to 60° C. A wet titanium dioxide filter cake treated with phosphate and alumina treatment was obtained.

### Comparative Example 10. Pigment Prepared with BIS and TMP

The wet titanium dioxide filter cake from Treatment Example 4 in an amount equal to 1000 g of dry pigment was mixed with deionized water to form a paste. Next, 3.00 g of bis(2,4,4,-trimethylpentyl) phosphinic acid (BIS) was added to the paste and mixed well therewith. The treated titanium dioxide paste was then dried in an oven at 115° C. to form a filter cake having a moisture content of less than 1%. Next, 8.48 g of a 33% trimethylolpropane (TMP) aqueous solution were sprayed on to the dry filter cake. The dried pigment was crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

### Comparative Example 11. Pigment Preparation with BIS and Glycerol

The wet titanium dioxide filter cake from Treatment Example 4 in an amount equal to 1000 g of dry pigment was mixed with deionized water to form a paste. Next, 3.00 g of bis(2,4,4,-trimethylpentyl) phosphinic acid (BIS) were added to the paste and mixed well therewith. The treated titanium dioxide paste was then dried in an oven at 115° C. to form a filter cake having a moisture content of less than 1%. Next, 4.00 g of glycerol was mixed with the dry filter cake. The dried pigment was crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

### Claimed Pigment Example 7. Pigment Preparation with BIS, Glycerol and TIPA

The wet titanium dioxide filter cake from Treatment Example 4 in an amount equal to 1000 g of dry pigment was mixed with deionized water to form a paste. Next, 3.00 g of bis(2,4,4,-trimethylpentyl) phosphinic acid (BIS) were added to the paste and mixed well therewith. The treated titanium dioxide paste was then dried in oven at 115° C. to form a filter cake having a moisture content of less than 1%. Next, 3.00 g of glycerol, and 1.00 g of an 85% TIPA mixture were added to the dry filter cake. The dried pigment was then crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

### Claimed Pigment Example 8. Pigment Preparation with BIS, Glycerol and Sodium Benzoate

The wet titanium dioxide filter cake from Treatment Example 4 in an amount equal to 1000 g of dry pigment was mixed with deionized water to form a paste. Next, 3.00 g of bis(2,4,4,-trimethylpentyl) phosphinic acid (BIS) were added to the paste and mixed well therewith. The treated titanium dioxide paste was then dried in oven at 115° C. to form a filter cake having a moisture content of less than 1%. Next, 2.00 g of sodium benzoate was dissolved in 10 g of deionized water and mixed with 2.00 g of glycerol to provide a chemical mixture. The chemical mixture was then added to the dry filter cake. The dried pigment was then crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

The results of the tests of Comparative Examples 10 and 11 and Claimed Pigment Examples 7 and 8 are shown by Table 6 below.

TABLE 6
Testing of phosphate and alumina treated TiO2 and its application in plastics

| | | | Claimed | Claimed |
|---|---|---|---|---|
| | Comparative | Comparative | Pigment | Pigment |
| | Example 10 | Example 11 | Example 7 | Example 8 |
| % Organic | 0.30% BIS, | 0.30% BIS, | 0.30% BIS, | 0.30% BIS, |
| chemical on TiO2 | 0.28% TMP | 0.30% Glycerol | 0.30% Glycerol, | 0.20% Glycerol, |
| | | | 0.10% TIPA | 0.20% sodium |
| | | | | benzoate |
| LLDPE | 1245 | 1295 | 1228 | 1234 |
| equilibrium | | | | |
| torque (m-g) | | | | |
| LLDPE screen | 107 | 219 | 107 | 135 |
| pack (ppm) | | | | |

As shown in Table 6, when only glycerol was used to replace TMP, both the equilibrium torque and screen pack residue were higher than with the control. On the other hand, when the blend of 0.3% glycerol and 0.1% TIPA (Claimed Pigment Example 8) and the blend of 0.2% glycerol and 0.2% sodium benzoate (Claimed Pigment Example 9) were used to replace TMP, both the equilibrium torque and the screen pack residue were comparable to the control.

### Testing Example 5: DOE Experiment-Silica and Alumina Treated Grade Titanium Dioxide Preparation with Glycerol and Triisopropanolamine (TIPA)

A DOE experiment was carried out to study the effects of glycerol and TIPA on silica and alumina treated titanium dioxide pigments.

In each test, the wet titanium dioxide filter cake from Treatment Example 1 in an amount equal to 1000 g of dry pigment was mixed with deionized water to provide a 50% slurry. A certain amount of an organic composition including TMP (Comparative Example 12) or a mixture of glycerol and TIPA (Claimed Pigment Examples 10-15), based on the dry weight of the titanium dioxide, was then mixed into the slurry. The organic treated titanium dioxide slurry was then dried in oven at 115° C. to a moisture content of less than 1%. The dried pigment was crushed to yield a dry pigment powder. The dry pigment powder was then steam micronized utilizing a steam to pigment weight ratio of 1.8:1 with the steam injector pressure set at 160 psi and the micronizer ring pressure set at 118 psi.

The finished pigments (Comparative Example 12 and Claimed Pigment Examples 10-15) were then tested according to Testing Examples 1 and 2, as described above, for their performance in coatings. During the experiment, duplicate samples were prepared for each organic composition. The results shown by Table 7 below are the average of the duplicate samples.

TABLE 7
The testing of silica and alumina treated TiO2 with glycerol/TIPA and its
application in coatings.

| | | % | % | % | Micro- | | | | Alkyd |
|---|---|---|---|---|---|---|---|---|---|
| | | TMP | glycerol | TIPA | trac, | | WB | Alkyd | dispersion, |
| Sample | | on | on | on | 0.630% | WB | Tint | dispersion, | fineness, |
| Code | Description | TiO2 | TiO2 | TiO2 | Pass | gloss | strength | Hegman | nibs |
| #1 | Comparative | 0.35 | | | 90.5 | 55 | 105 | 7.1 | 27 |
| | Example 12 | | | | | | | | |
| #2 | Claimed | | 0.55 | 0.25 | 91.0 | 58 | 106 | 7.5 | 28 |
| | Pigment | | | | | | | | |
| | Example 10 | | | | | | | | |
| #3 | Claimed | | 0.35 | 0.25 | 90.2 | 58 | 106 | 7.6 | 29 |
| | Pigment | | | | | | | | |
| | Example 11 | | | | | | | | |
| #4 | Claimed | | 0.45 | 0.15 | 91.5 | 56 | 106 | 7.2 | 25 |
| | Pigment | | | | | | | | |
| | Example 12 | | | | | | | | |
| #5 | Claimed | | 0.5 | 0.1 | 91.2 | 55 | 106 | 7.1 | 30 |
| | Pigment | | | | | | | | |
| | Example 13 | | | | | | | | |
| #6 | Claimed | | 0.55 | 0.05 | 91.3 | 54 | 105 | 7.2 | 32 |
| | Pigment | | | | | | | | |
| | Example 13 | | | | | | | | |
| #7 | Claimed | | 0.35 | 0.05 | 90.6 | 52 | 105 | 7.1 | 31 |
| | Pigment | | | | | | | | |
| | Example 15 | | | | | | | | |

Table 7 shows confirms that the combination of glycerol and TIPA exhibits comparable properties to the pigment prepared with TMP.

### Treatment Example 5. Preparation of Titanium Dioxide Filter Cake without Inorganic Treatment

Titanium dioxide pigment particles formed by the chloride process were dispersed in water to form a raw slurry having a pH of 3-4. The resulting slurry was then subjected to sand milling (using a zircon sand-to-pigment weight ratio of 4:1) until 90% of the particles were smaller than 0.63 microns (as determined by a Microtrac X 100 Particle Size Analyzer) to achieve an aqueous dispersion with a solids content of 35%.

The resulting slurry, diluted to a 30% solids content, was then heated to 85° C. and the pH was adjusted to 7.0 with a sodium hydroxide solution. The slurry was then allowed to digest for another 10 minutes, and was then filtered while hot. The resulting filtrate was washed with water, which had been preheated to 60° C. A wet titanium dioxide filter cake without inorganic treatment was obtained.

### Comparative Example 13. Pigment Prepared with BIS and TMP

The wet titanium dioxide filter cake from Treatment Example 5 in an amount equal to 1000 g of dry pigment was mixed with deionized water to form a paste. Next, 3.10 g of bis(2,4,4,-trimethylpentyl) phosphinic acid (BIS) were added to the paste and mixed well therewith. The treated titanium dioxide paste was then dried in an oven at 115° C. to form a filter cake having a moisture content of less than 1%. Next, 4.85 g of a 33% trimethylolpropane (TMP) aqueous solution were added to the dry filter cake. The dried pigment was crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

### Claimed Pigment Example 16. Pigment Preparation with BIS, Glycerol and TIPA

The wet titanium dioxide filter cake from Treatment Example 5 in an amount equal to 1000 g of dry pigment was mixed with deionized water to form a paste. Next, 3.10 g of bis(2,4,4,-trimethylpentyl) phosphinic acid (BIS) were added to the paste and mixed well therewith. The treated titanium dioxide paste was then dried in oven at 115° C. to form a filter cake having a moisture content of less than 1%. Next, 1.00 g of glycerol, and 0.71 g of an 85% TIPA solution were added to the dry filter cake. The dried pigment was then crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

### Claimed Pigment Example 17. Pigment Preparation with BIS, Glycerol and Sodium Benzoate

The wet titanium dioxide filter cake from Treatment Example 5 in an amount equal to 1000 g of dry pigment was mixed with deionized water to form a paste. Next, 3.00 g of bis(2,4,4,-trimethylpentyl) phosphonic acid (BIS) were added to the paste and mixed well therewith. The treated titanium dioxide paste was then dried in oven at 115° C. to form a filter cake having a moisture content of less than 1%. Next, 0.60 g of sodium benzoate was dissolved in 10 g of deionized water and mixed with 1.00 g of glycerol to provide a chemical mixture. The chemical mixture was then added to the dry filter cake. The dried pigment was then crushed to yield a dry pigment powder. The dry pigment powder was then steam micronized utilizing a steam to pigment weight ratio of 2.5:1 with the steam injector pressure set at 160 psi and the micronizer ring pressure set at 118 psi.

The results of the tests of Comparative Examples 13 and Claimed Pigment Examples 16 and 17 are shown by Table 8 below.

TABLE 8
Testing of no inorganic treated TiO2 and its application in plastics.

| | Comparative | Claimed Pigment | Claimed Pigment |
|---|---|---|---|
| | Example 13 | Example 16 | Example 17 |
| % Organic | 0.31% BIS, | 0.31% BIS, | 0.31% BIS, |
| chemical on TiO2 | 0.16% TMP | 0.10% Glycerol, | 0.10% Glycerol, |
| | | 0.06% TIPA | 0.06% sodium |
| | | | benzoate |
| LLDPE equilibrium | 1086 | 1154 | 1125 |
| torque (m-g) | | | |
| LLDPE screen | 128 | 105 | 105 |
| pack (ppm) | | | |

As shown in Table 8, When the blend of 0.1% glycerol and 0.06% TIPA (Claimed Pigment Example 16) and the blend of 0.1% glycerol and 0.06% sodium benzoate (Claimed Pigment Example 17) were used to replace TMP, both the equilibrium torque and the screen pack residue were comparable to the control.

Thus, the above examples demonstrate that the organic treating agent used in producing a treated, titanium dioxide pigment in accordance with the process disclosed herein and in connection with the titanium dioxide pigment disclosed herein is comparable to TMP. The first component and second component of the treating agent synergistically work together to achieve excellent results.

For example, as shown by Tables 3, 4, 5 and 7 above, if only glycerol is used, the particle size distribution of the finished pigments is not acceptable and the performance of the pigment in coatings is poor. However, when a relatively small amount of a carboxylic acid (or salt thereof) or alkanolamines is used, there are huge improvement in particle size and coating performance.

Thus, the pigments, compositions and methods are well adapted to attain the ends and advantages mentioned, as well as those that are inherent therein. The particular examples disclosed above are illustrative only, as the present pigments, compositions and methods may be modified and practiced in different but equivalent manners apparent to those skilled in the art having the benefit of the teachings herein. It is therefore evident that the particular illustrative examples disclosed above may be altered or modified, and all such variations are considered within the scope and spirit of the present pigments, compositions and methods. While the pigments, compositions and methods are described in terms of “comprising,” “containing,” “having,” or “including” various components or steps, the pigments, compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

What is claimed is:

1. A process for producing a treated, titanium dioxide pigment, comprising:
providing a plurality of titanium dioxide pigment particles; and
depositing an organic treating agent on the surfaces of said pigment particles to form a coating of said organic treating agent thereon, wherein said organic treating agent includes:
a first component consisting of at least one polyhydric alcohol; and
a second component selected from the group consisting of carboxylic acids and salts thereof, alkanolamines, and combinations thereof.

2. The process of claim 1, wherein said organic treating agent is deposited on the surfaces of said pigment particles in an amount in the range of from about 0.1% to about 1% by weight, based on the weight of said titanium dioxide particles.

3. The process of claim 1, wherein said ratio of said first component to said second component in said treating agent is in the range of from about 1:1 to about 20:1.

4. The process of claim 1, wherein said polyhydric alcohol of said first component of said organic treating agent is selected from the group consisting of glycerol, polyglycerol, mannitol, xylitol, erythritol, and combinations thereof.

5. The process of claim 1, wherein said second component of said organic treating agent is at least one carboxylic acid and/or salt thereof.

6. The process of claim 5, wherein said carboxylic acid and/or salt thereof is selected from the group consisting of monocarboxylic acids, dicarboxylic acids, hydroxyl carboxylic acids, salts of monocarboxylic acids, salts of dicarboxylic acids, salts of hydroxyl carboxylic acids, and combinations thereof.

7. The process of claim 6, wherein said carboxylic acid and/or salt thereof is selected from the group consisting of benzoic acid, adipic acid, propionic acid, citric acid, lactic acid, tartaric acid, salts of benzoic acid, salts of adipic acid, salts of propionic acid, salts of citric acid, salts of lactic acid, salts of tartaric acid, and combinations thereof.

8. The process of claim 7, wherein said carboxylic acid and/or salt thereof is selected from the group of benzoic acid and salts thereof.

9. The process of claim 1, wherein said second component of said organic treating agent is at least one alkanolamine.

10. The process of claim 9, wherein said alkanolamine is selected from the group consisting of hydroxylamines, triisopropanolamine (TIPA), triethanolamine (TEOA), tris(hydroxymethyl)aminomethane, and combinations thereof.

11. The pigment of claim 10, wherein said alkanolamine is a triisopropanolamine (TIPA).

12. The process of claim 1, wherein said first component of said organic treating agent is deposited on said surfaces of said pigment particles in an amount in the range of from about 0.1% to about 0.99% by weight, based on the weight of the titanium dioxide particles, and said second component of said organic treating agent is deposited on said surfaces of said pigment particles in an amount in the range of from about 0.01% to about 0.9% by weight, based on the weight of the titanium dioxide particles.

13. The process of claim 12, wherein said second component is at least one carboxylic acid and/or salt thereof, and is deposited on said surfaces of said pigment particles in an amount in the range of from about 0.1% to about 0.6% by weight, based on the weight of the titanium dioxide particles.

14. The process of claim 12, wherein said second component is at least one alkanolamine, and is deposited on said surfaces of said pigment particles in an amount in the range of from about 0.01% to about 0.2% by weight, based on the weight of the titanium dioxide particles.

15. The process of claim 1, further comprising:
prior to depositing said organic treating agent on said surfaces of said pigment particles:
depositing an inorganic treating agent on the surfaces of said pigment particles to form a coating of said inorganic treating agent thereon.

16. The process of claim 1, wherein said organic treating agent is a second organic treating agent, and said process further comprises:
depositing a first organic treating agent on the surfaces of said pigment particles to form a coating of said first organic treating agent thereon.

17. The process of claim 16, wherein said first organic treating agent is deposited on said surfaces of said pigment particles prior to depositing said second organic treating agent on said surfaces of said pigment particles.

18. The process of claim 16, wherein said first organic treating agent is selected from the group consisting of alkyl phosphinic acids, derivatives of alkyl phosphinic acids, phosphonic acids, derivatives of phosphonic acids, siloxanes, and combinations thereof.

19. The process of claim 18, wherein said first organic treating agent is selected from the group consisting of alkyl phosphinic acids, phosphonic acids, siloxanes, and combinations thereof.

20. The process of claim 10, wherein said first organic treating agent consists of one or more alkyl phosphinic acids.

21. The process of claim 20, wherein said first organic acid is bis(2,4,4,-trimethylpentyl) phosphinic acid.

22. The process of claim 20, wherein said first treating agent is deposited on said surfaces of said pigment particles in an amount in the range of from about 0.05% to about 1.0% by weight, based on the weight of said pigment particles.

23. A treated titanium dioxide pigment, comprising:
a plurality of titanium dioxide particles; and
an organic treating agent deposited on the surfaces of said titanium dioxide particles and forming a coating of said organic treating agent thereon, wherein said organic treating agent includes:
a first component consisting of at least one polyhydric alcohol; and
a second component selected from the group consisting of carboxylic acids and salts thereof, alkanolamines, and combinations thereof.

24. The pigment of claim 23, wherein said polyhydric alcohol of said first component of said organic treating agent is selected from the group consisting of glycerol, polyglycerol, mannitol, xylitol, erythritol, and combinations thereof.

25. The pigment of claim 23, wherein said second component of said treating agent is at least one carboxylic acid and/or salt thereof.

26. The pigment of claim 25, wherein said carboxylic acid and/or salt thereof is selected from the group consisting of benzoic acid, adipic acid, propionic acid, citric acid, lactic acid, tartaric acid, salts of benzoic acid, salts of adipic acid, salts of propionic acid, salts of citric acid, salts of lactic acid, salts of tartaric acid, and combinations thereof.

27. The pigment of claim 26, wherein said carboxylic acid and/or salt thereof is selected from the group of benzoic acid and salts thereof.

28. The pigment of claim 23, wherein said second component of said treating agent is at least one alkanolamine.

29. The pigment of claim 28, wherein said alkanolamine is selected from the group consisting of hydroxylamines, triisopropanolamine (TIPA), triethanolamine (TEOA), tris(hydroxymethyl)aminomethane, and combinations thereof.

30. The pigment of claim 29, wherein said alkanolamine is a triisopropanolamine (TIPA).

31. The pigment of claim 23, wherein said organic treating agent is a second organic treating agent, and said pigment further comprises a first organic treating agent deposited on the surfaces of said pigment particles to form a coating of said first organic treating agent thereon.

32. The pigment of claim 31, wherein said second organic treating agent is deposited on top of said first organic treating agent.

33. The process of claim 31, wherein said first organic treating agent is selected from the group consisting of alkyl phosphinic acids, derivatives of alkyl phosphinic acids, phosphonic acids, derivatives of phosphonic acids, siloxanes, and combinations thereof.

34. The process of claim 33, wherein said first organic treating agent is selected from the group consisting of alkyl phosphinic acids, phosphonic acids, siloxanes, and combinations thereof.

35. The process of claim 34, wherein said first organic treating agent consists of one or more alkyl phosphinic acids.

36. The process of claim 35, wherein said first organic acid is bis(2,4,4,-trimethylpentyl) phosphinic acid.

37. The process of claim 31, wherein said first treating agent is deposited on said surfaces of said pigment particles in an amount in the range of from about 0.05% to about 1.0% by weight, based on the weight of said pigment particles.
